(19) United States
(12) Patent Application Publication
(10) Pub. No.: US 2024/0299969 A1
(43) Pub. Date: Sep. 12, 2024

(54) Coating Head, with Movable Rod

(71) Applicant: VALCO MELTON, S.L.U., Orcoyen (Navarra) (ES)

(72) Inventors: Gonzalo Marco Noain, Orcoyen (Navarra) (ES); Alaine Salterain Gonzalez, Orcoyen (Navarra) (ES)

(21) Appl. No.: 18/599,585

(22) Filed: Mar. 8, 2024

(30) Foreign Application Priority Data
Mar. 10, 2023 (ES) P202330205

(51) Int. Cl. B05C 5/02

(52) U.S. Cl. CPC B05C 5/02

(57) ABSTRACT

A coating head includes a fluid passage channel that opens into a fluid discharge region; a movable rod located in the fluid discharge region, arranged after the first edge of the fluid passage channel and close to the perimeter of a rotating roller on which a substrate is arranged; and an inlet lip provided with a straight internal side that is oblique to the perimeter of the rotating roller and that defines the second edge of the fluid passage channel, of a flat face facing the rotating roller and an external side, the latter provided with a step.

### CROSS-REFERENCE TO RELATED APPLICATION

This application claims priority to Spanish Patent Application No. P202330205 filed Mar. 10, 2023, the disclosure of which is hereby incorporated by reference in its entirety.

### BACKGROUND OF THE INVENTION

### Field of the Invention

The present invention is useful in continuous and intermittent industrial coating processes, by means of which a layer of a fluid material is deposited on a movable substrate, forming a coating on this substrate. These coating processes are frequently used in the manufacture, among others, of products such as labels, adhesive tapes and textile products.

More particularly, said invention relates to a coating head of the type provided with a movable rod, which configuration and design, among other advantages, optimise the process of distributing the coating material on the substrate, in addition to extending the range of application.

### Description of Related Art

Coating heads are commonly used in various applications where a fluid of complex rheology (for example, but not limited to, a hot melt adhesive, cold glue or wax) must be discharged onto a movable substrate, so that a layer of said fluid is deposited on the substrate, generating a coating.

In such applications, the fluid exits the head, coming into contact with the movable substrate which is usually on a rotating roller. In this process, an interaction between the fluid flow, the movable substrate and the atmospheric air takes place.

The efficiency of the coating process depends largely on the design of the heads, as well as the operating conditions set according to the requirements of the end user. These requirements include the coating fluid, the application width (m), the line speed (m/min) and the grammage (gr/m²). The latter impose the operating condition regarding the mass flow rate of the coating fluid. The requirement of coating thickness, normally expressed in units of microns, can be equivalent to the requirement of grammage, resulting in the ratio between grammage and fluid density.

For a coating process to be considered efficient, for certain operating conditions it is necessary that the configuration of the head (thickness of the channel or separation of the sides) produce a mass flow of fluid that is as uniform as possible in the direction of the application width and thus avoid the appearance of imperfections or discontinuities that are noticeable to the naked eye, such as streaks and/or wrinkles.

Likewise, if the distance between the head and the substrate is not adequate and/or if there is excessive interaction between air and the fluid, imperfections may appear, such as:
Bubbles, mainly due to the inlet of air into the coating system;
Thickening at the edge of the fluid layer, caused by excessive fluid accumulation;
Defects in the distribution of the grammage, due to the flow transfer in the meniscus (curved separation surface between the coating fluid and the atmospheric air that is located upstream of the discharge region).

At present, two different types of coating heads are commercially available: those provided with a movable rod and those without it.

In the first type of heads (with a movable rod), the fluid is subjected to pressure so that it circulates through a channel until it reaches a discharge region in which a movable rod is arranged, close to a substrate that is also movable and placed on a rotating roller. The rod and the substrate force the fluid flow into the discharge region, generating a fluid layer on the substrate. The distance between the rod and the substrate is adapted or established depending on the application, setting the thickness of the layer to be obtained between 0.5 and 2 times.

Compared to other already known devices, the use of coating heads provided with rods makes it possible to improve the uniformity of the fluid layer formed on the substrate, thus avoiding the appearance of streaks and/or wrinkles. Furthermore, the coating heads provided with rods make it possible to coat substrates with a very low grammage, less than 10 g/m².

However, the coating heads provided with a movable rod that are part of the prior art do not allow working with conditions that generate thicknesses of more than 50 g/m², since under these working conditions thickening tends to appear on the edge, caused by the accumulation of fluid. Likewise, these heads have limitations when working with coating fluids which viscosity is greater than 100,000 mPa·s or less than 500 mPa·s.

The second type of coating heads is the type without movable rods. In this type of devices, the pressurised fluid also circulates through a fluid passage channel until reaching a discharge region. Said discharge region is delimited by an inlet lip that rests on the substrate (arranged on a rotating roller) and an outlet lip provided with a flat face substantially parallel to the substrate and close to it (usually at a distance between 0.5 and 2 times the thickness of the layer to be obtained). The outlet lip is intended, in turn, to coat the fluid, pressing it against the substrate.

The inlet and outlet lips together with the action of the movable substrate exert pressure in the discharge region that determines the fluid flow to produce the coating.

Throughout this description, it must be understood, on the one hand, that the inlet lip is the lip through which the movable substrate first passes and it is located upstream of the discharge region. One of the functions of this lip is to place the meniscus in a suitable position. On the other hand, the outlet lip is the lip located downstream of the discharge region and its purpose is to produce the pressure gradient required to avoid defects such as the accumulation of fluid at its outlet.

The coating heads of the second type (without a rod) that are part of the prior art allow generating high grammages, but have the drawback that low grammage coatings cannot be generated with them and, moreover, they are very sensitive to the appearance of longitudinal defects in the application due to contamination in the coating fluid that is applied.

Therefore, there is a need in the art to develop a new coating head that has both the advantages of heads with a movable rod and the advantages of heads without said rod. Mainly, a coating head that is capable of generating both high and low grammage coatings working in a wide range of line speeds.

### SUMMARY OF THE INVENTION

The present invention aims to overcome the drawbacks and limitations noted above in the devices of the prior art.

For this purpose, an object of the present invention relates to a coating head with a movable rod comprising:
a fluid passage channel that opens into a discharge region and is delimited by a first edge and a second edge parallel to each other, the fluid being intended to form a coating on a substrate arranged on a rotating roller located in the discharge region; and
a movable rod that partially delimits the discharge region and is arranged following the first edge of the fluid passage channel tangent to it, the movable rod being located so that the minimum distance between its perimeter and the substrate is equal to or less than between 0.5 and 2 times the thickness of the coating;
   characterised in that said coating head also comprises an inlet lip provided with:
a straight internal side, which forms a second angle with the plane defined by the centre of the rod and the generatrix of the perimeter of the rod closest to the substrate, a portion of said internal side of the inlet lip defining the second edge of the fluid passage channel
a flat face arranged forming a first angle with the straight internal side and a third angle with the plane tangent to the movable rod that passes through the generatrix of the perimeter of said rod closest to the substrate; and
an external side, provided with a step . . . .

In the coating heads according to the present invention, the third angle is between −20° and +20°. Likewise, in one embodiment of the invention, the third angle is equal to zero.

Throughout the present invention, the third angle defined in the previous paragraph is understood to be positive when taken towards the straight internal side of the inlet lip and negative when taken in the opposite direction.

The incorporation into the design of the inlet lip with its flat face sufficiently close to the substrate ensures the positioning of the fluid meniscus on said face and a working pressure in the discharge region that prevents the inlet of air entrained by the substrate (which would generate bubbles) and the outlet of the adhesive through the meniscus (which would generate thickening or defects in the homogeneity of the thickness).

In turn, this pressure facilitates the exit of the adhesive through the gap between the rod and the substrate, making it possible to work with different flow rates that produce higher or lower grammages/thicknesses, ensuring the correct operation of the system.

The lack of an inlet lip, or an excessive distance from the same to the generatrix of the perimeter of the movable rod closest to the substrate, means that the pressure in the discharge region is practically non-existent, causing either the meniscus to not be generated or, if it is generated, to not have a stable position. Consequently, the coating fluid can move in a transverse direction, making the result more sensitive to the inlet of air, generating defects in the application.

Given the elements that make up the coating head according to the present invention and the specific arrangement thereof described above, said coating head is capable of extending the range of working flow rates and viscosities with respect to those of the coating heads with movable rods of the prior art, until reaching working flow rates that generate high grammages (greater than 60 g/m²) or extreme viscosities (less than 500 mPa·s or greater than 100,000 mPa·s) and simultaneously avoiding the appearance of thickening and other defects, such as bubbles and/or defects in the homogeneity of the fluid distribution.

Preferably, the flat face of the inlet lip has an extension between 2 mm and 5 mm. This extension of the flat face within this range of values optimises the pressure distribution on the fluid existing between the head and the movable substrate, favouring the inclusion of the meniscus within said extension of the flat face.

On the other hand, in the coating heads according to the present invention, the intersection of the straight internal side with the flat face of the inlet lip can be separated by a vertical distance, between-3 mm and +3 mm, with respect to the plane tangent to the movable rod that passes through the generatrix of the perimeter of said rod closest to the substrate.

The value of the vertical distance is understood as positive if the distance is taken approaching the centre of the movable rod and negative in the opposite direction.

Likewise, in one embodiment of the invention, the third angle is equal to zero and the vertical distance is equal to zero. In this particular case, the flat face of the inlet lip is tangent to the generatrix of the perimeter of the movable rod closest to the substrate, also fulfilling the fact that the first angle and the second angle are complementary to each other.

On the other hand, in the coating heads according to the present invention, the first angle is preferably between 30° and 60°.

This specific configuration allows establishing an average pressure in the discharge region that causes the position of the meniscus (separation surface between the coating fluid and the atmospheric air) to be located within the length of the flat face of the inlet lip, which improves the properties of the coating, reducing the appearance of possible defects in the same.

An angle less than 30° C. an generate geometries that are fragile and difficult to manufacture, which can cause the first straight section of the step on the external side to be confused with the flat face of the inlet lip and the meniscus to grow, generating grammage defects in the longitudinal direction.

For angles greater than the aforementioned range, the pressure in the discharge area may not ensure correct positioning of the meniscus. On the other hand, using angles smaller than the aforementioned range could compromise the structural strength of the piece. Furthermore, an angle greater than 60° could mean that the discharge region has a size such that the fluid can move in a transverse direction, generating a defect in the thickness, thickening at the end and changes in the width of the application.

In the coating heads of the invention, the distance between the plane tangent to the movable rod that passes through the generatrix of said movable rod closest to the substrate and the flat face of the inlet lip is preferably between 0 and 3 mm.

In one embodiment of the invention, the step on the external side of the inlet lip is formed by the intersection of a first straight section with a second straight section. Likewise, the first straight section of the external side of the inlet lip is preferably parallel to the straight internal side of the inlet lip.

The inlet side may also optionally comprise, in addition to a first straight section and a second straight section which intersection forms the step, a third straight section arranged after the second straight section.

### BRIEF DESCRIPTION OF THE DRAWINGS

The terms Fig., Figs., Figure, and Figures are used interchangeably in the specification to refer to the corresponding figures in the drawings.

To complete the description and for the purpose of helping to make the features of the present invention more readily understandable, this description is accompanied by a set of figures constituting an integral part of the same, which by way of illustration and not limitation represents the following:

FIG. 1 is a general sectional view of a coating head according to the present invention;

FIG. 2 is a schematic sectional view of a detail of a coating head, according to a first embodiment of the present invention;

FIGS. 3A and 3B are schematic sectional views, on an enlarged scale, of a detail of a coating head according to a second embodiment of the present invention and illustrating the passage of fluid through the channel and the subsequent formation of the coating on the substrate; and

FIG. 4 is a schematic sectional view in which, in addition to the portion of the coating head of the invention visible in FIGS. 2, 3A and 3B, the rotating roller on which the substrate to be coated is arranged is also shown.

### REFERENCES OF THE FIGURES

1) Fluid passage channel;
1a) First edge (of the fluid passage channel);
1b) Second edge (of the fluid passage channel);
1c) Line of tangency between the first edge of the fluid passage channel and the perimeter of the movable rod;
2) Fluid discharge region;
3) Movable rod;
3a) Generatrix of the perimeter of the movable rod closest to the substrate;
4) Rotating roller on which the substrate is placed;
5) Inlet lip;
5a) Straight internal side of the inlet lip;
5b) Flat face (of the inlet lip);
5c) First section of the step of the external side (of the inlet lip);
5d) Second section of the step of the external side (of the inlet lip);
5e) Third section of the external side (of the inlet lip);
6) Central body (of the coating head);
7) Outlet lip;
8) Coating fluid;
8a) Meniscus;
9) Movable substrate;
L_{d}) Length of the flat face of the inlet lip;
w) Rotation speed of the roller on which the substrate is placed;
V) Linear speed of the substrate;
θ₁) First angle. It is the one described between the internal side of the inlet lip and the flat face of the inlet lip;
θ_{c}) Second angle. It is the one formed by the internal side of the inlet lip with the plane defined by the centre of the rod and the generatrix of the perimeter of the rod closest to the substrate.
β) Third angle. It is the one formed between the flat face of the inlet lip and the plane tangent to the movable rod that passes through the generatrix of the perimeter of said rod closest to the substrate;
OR) Centre of the rotating roller;
OV) Centre of the movable rod;
Y) Global axis defined by an arbitrary direction and with origin at the centre of the roller. The positive direction of this axis is from OR to OV;
X) Global axis with origin at the centre of the roller and defined by a direction perpendicular to the Y-axis; The positive direction of this axis is from the centre of the roller towards the inlet lip;
h) Minimum distance between the perimeter of the movable rod and the movable substrate;
I) Intersection of the straight internal side with the flat face of the inlet lip.
k) Vertical distance between the intersection and the generatrix of the rod closest to the substrate;
Cₓ) Decentering of the centre of the rod along the X-axis that implies displacement;
C_{y}) Distance measured on the Y-axis between the centre of the roller and the centre of the movable rod;
T) Plane tangent to the movable rod in the generatrix of the rod closest to the substrate;
Q) Fluid flow.

### DESCRIPTION OF THE INVENTION

Throughout this description, as well as in the attached figures, the elements that have the same or similar function are denoted with the same reference numbers.

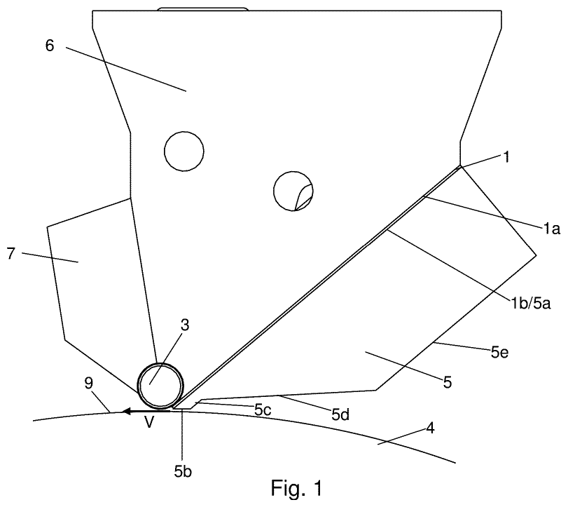

FIG. 1 shows a first exemplary coating head according to the present invention. In the embodiment shown, said head comprises an inlet lip (5), a central body (6), an outlet lip (7) and a movable rod (3) arranged after the outlet lip (7), these elements next to the movable substrate (9) delimiting a fluid discharge region (2).

The central body (6) and the inlet lip (5) are located close to each other, although they are not in contact, so that they delimit a fluid passage channel (1), which opens into the fluid discharge region (2). More particularly, the internal side of the central body (6) defines the first edge (1a) of the fluid passage channel (1), while the internal side (5a) of the inlet lip corresponds to the second edge (1b) of the fluid passage channel (1).

In this embodiment of the invention, the inlet lip (5) also comprises a flat face (5b) and following that, three straight sections (5c, 5d and 5e) where the second straight section (5c) is also parallel to the internal side (5a). The flat face (5b) faces the movable substrate (9) placed on the roller (4), said substrate being moved at a specific speed (V).

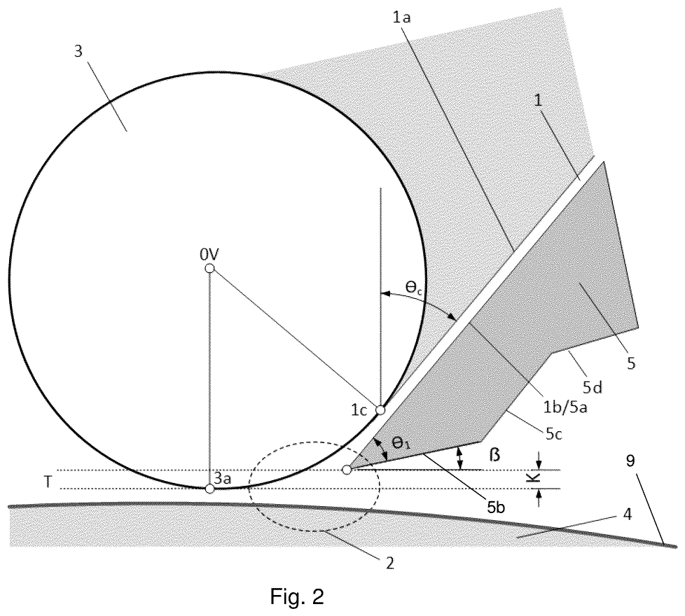

FIG. 2 shows a detail of a coating head, according to a first embodiment of the present invention. This figure shows the first angle (θ₁), which is the angle described between the internal side (5a) of the inlet lip (5) and the flat face (5b) of the inlet lip, as well as the second angle (θ_{c}), formed between the internal side (5a) of the inlet lip and the plane defined by the centre (OV) of the rod (3) and the generatrix (3a) of the perimeter of the rod (3) that is closest to the substrate (9). In this particular case, the first angle (θ₁) has a value between 30 and 60°.

Furthermore, in the embodiment shown in FIG. 2, the direction of the flat face (5b) of the inlet lip (5) does not coincide with the direction of the plane (T) tangent to the generatrix (3a) of the movable rod (3) closest to the substrate (9), both directions being separated from each other by a third angle (β), less than 20 degrees.

In fact, in the coating heads of the present invention, the following relationship between the different angles is satisfied:

$${θ}_{C} = \frac{π}{2} - ( {θ}_{1} + β )$$

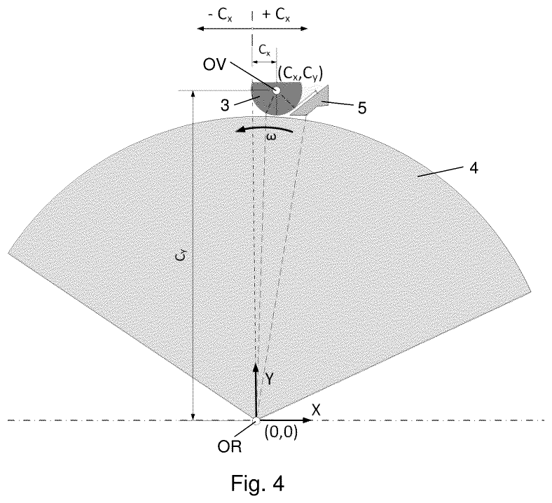

Likewise, the generatrix (3a) of the movable rod (3) closest to the substrate (9) is displaced vertically (i.e., along the Y-axis shown in FIG. 4) a distance (k) with respect to the intersection (I) of the straight internal side (5a) and the flat face (5b).

FIG. 2 also shows the line (1c), which corresponds to the rim of the first edge (1a) of the fluid passage channel, which is tangent to the perimeter of the movable rod, delimiting the fluid discharge region (2).

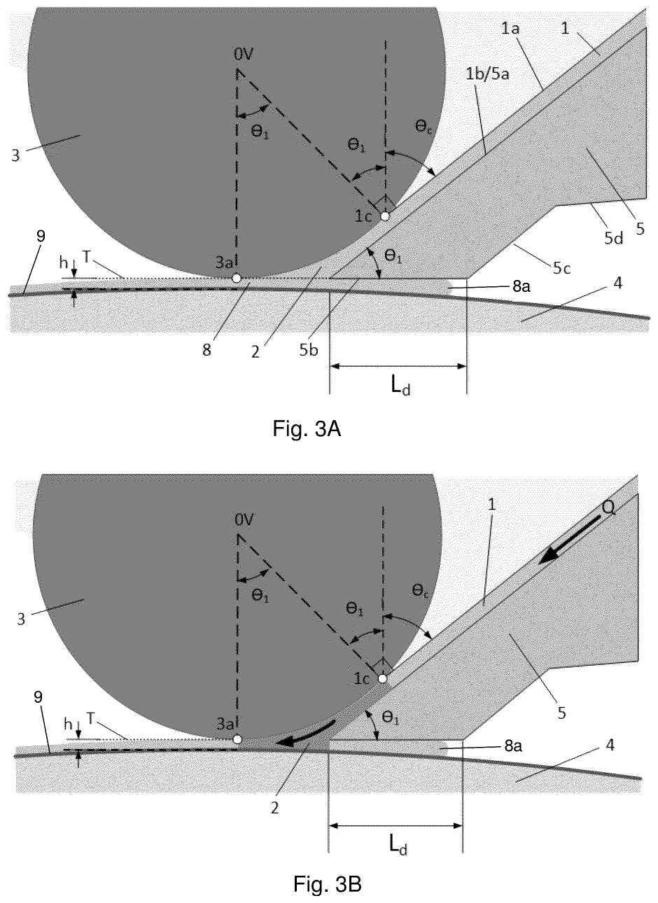

FIGS. 3A and 3B schematically show how the fluid (8) circulates in a coating head according to the present invention until it forms a coating on the movable substrate (9).

In the particular embodiment shown in said FIGS. 3A and 3B, the third angle (β) is equal to zero and k is also equal to zero, such that the direction of the flat face (5b) of the inlet lip (5) coincides with the direction of the plane (T) tangent to the generatrix (3a) of the movable rod (3) closest to the substrate (9). Furthermore, the first angle (θ₁) and the second angle (θ_{c}) are complementary to each other.

Thus, FIG. 3B shows with arrows how a fluid (8) flow (Q) circulates through the channel (1) until it reaches the fluid discharge region (2) where it comes in contact with the substrate (9), which is arranged on the movable roller (4), thus forming a coating on said substrate (9).

Likewise, FIG. 3A shows the distance (h) which is the minimum distance existing between the perimeter of the movable rod (3) and the movable substrate (9). Furthermore, the plane (T) tangent to the generatrix (3a) of said movable rod closest to the substrate (9) is shown.

In addition to other elements of the head, already explained previously, in relation to the previous figures, FIG. 3A also shows the first angle (θ₁), which corresponds to the angle described between the internal side (5a) of the inlet lip (5) and the flat face (5b) of the inlet lip, as well as the second angle (θ_{c}), complementary to the angle (θ₁).

FIGS. 3A and 3B also show the distance (La) that defines the extension of the flat face (5b) of the inlet lip, the generatrix (3a) of the movable rod (3) that is closest to the substrate (9) placed on the rotating roller (4). In this particular case, the extension of the flat face (5b) is between 2 mm and 5 mm.

Likewise, FIG. 3A also shows how, when the head is operating, the fluid (8) circulates through the channel (1) in the direction shown by the arrows visible in FIG. 3B, penetrating the discharge region (2) where, in turn, it comes in contact with the movable substrate (9), which is placed on the rotating roller (4). The flow of the fluid in the discharge region on the one hand produces the coating on the movable substrate (9) and also fixes the position of the meniscus (8a).

A correct coating will be produced upon achieving correct positioning of the fluid meniscus (8a). If the fluid pressure at the point on the flat face of the inlet lip (5b) located close to the rod (3) exceeds the value of atmospheric pressure, and the pressure at the point on the flat face of the inlet lip (5b) further away from the rod (3) were at a lower value and close to the atmospheric pressure, the fluid meniscus (8a) would be located along the flat face of the inlet lip (5b). Otherwise, different imperfections could occur on the coating, either because atmospheric air would penetrate into the discharge area (2) or because the meniscus (8a) exceeds the flat face (5b) of the inlet lip (5) and the correct fluid flow required in the coating could not be ensured.

FIG. 4 shows an enlargement of FIGS. 1 and 3A and in it, in addition to the aforementioned elements, the positioning of the head object of the present invention is defined with respect to the rotating roller (4) on which the substrate is located (9). The global reference system is shown with origin at the centre of said roller (OR) and formed by the X and Y-axes.

In addition, the parameter (Cₓ), which corresponds to the coordinate on the horizontal axis (X) of the centre (OV) of the movable rod (3), as well as the parameter (C_{y}), which corresponds to the coordinate on the vertical axis (Y) of the centre of the movable rod (3), are also represented. In this way, the coordinates of the rotation axis of said movable rod (3) are (Cₓ, C_{y}) in this particular case.

The present invention is in no way limited to the embodiments herein disclosed. For a person skilled in the art, other possible different embodiments of this invention will be evident in light of the present description. As a result, the scope of protection of the present invention is exclusively defined by the claims that follow.

1. A coating head with movable rod, comprising:
a fluid passage channel, which opens into a fluid discharge region and is delimited by a first edge and a second edge parallel to each other, the fluid being intended to form a coating on a substrate arranged on a rotating roller located in the discharge region and
a movable rod that partially delimits the fluid discharge region and is arranged following the first edge of the fluid passage channel tangent to it, the movable rod being located so that the minimum distance between its perimeter and the substrate is equal to or less than between 0.5 and 2 times the thickness of the coating;
wherein said coating head also comprises an inlet lip provided with:
a straight internal side, which forms a second angle with the plane defined by the centre of the rod and the generatrix of the rod closest to the substrate, a portion of the internal side of the inlet lip defining the second edge of the fluid passage channel;
a flat face arranged forming a first angle with the straight internal side and a third angle with the plane tangent to the movable rod that passes through the generatrix of the perimeter of said movable rod closest to the substrate; and
an external side provided with a step.

2. The coating head of claim 1, wherein the flat face of the inlet lip has an extension between 2 mm and 5 mm.

3. The coating head of claim 1 wherein the third angle is comprised between −20° and +20°.

4. The coating head of claim 3, wherein the third angle is equal to zero.

5. The coating head of claim 1, wherein the first angle is between 30 and 60°.

6. The coating head of claim 1, wherein the distance between the plane tangent to the movable rod that passes through the generatrix of said movable rod, closest to the substrate, and the flat face of the inlet lip is between 0 and 3 mm.

7. The coating head of claim 1, wherein the vertical distance between the intersection of the straight internal side with the flat face of the inlet lip and the generatrix of the perimeter of the movable rod closest to the substrate is between −3 mm and +3 mm.

8. The coating head of claim 7, wherein the vertical distance is equal to zero.

9. The coating head of claim 1, wherein the step on the external side of the inlet lip is formed by the intersection of a first straight section and a second straight section.

10. The coating head of claim 9, wherein the first straight section of the external side of the inlet lip is parallel to the straight internal side of the inlet lip.

11. The coating head of claim 9, wherein the external side of the inlet lip further comprises a third straight section arranged after the second straight section.

12. The coating head of claim 10, wherein the external side of the inlet lip further comprises a third straight section arranged after the second straight section.
